(19) United States
(12) Patent Application Publication
(10) Pub. No.: US 2017/0181400 A1
(43) Pub. Date: Jun. 29, 2017

(54) SPILL RESISTING PET WATER VESSEL FOR USE IN MOTOR VEHICLES

(71) Applicant: Jonathan Hoffman, Agoura Hills, CA (US)

(72) Inventor: Jonathan Hoffman, Agoura Hills, CA (US)

(21) Appl. No.: 14/979,467

(22) Filed: Dec. 27, 2015

(51) Int. Cl. A01K 7/00

(52) U.S. Cl. CPC A01K 7/005

(57) ABSTRACT

A one piece monolithic spill resisting water vessel made of a flexible material, intended for pets for use in a motor which solves the problems of water sloshing and spilling due to both vehicle motion and pet drinking mechanics, which fits in a vehicle cup holder. The functionality, flexibility, size, cost, simplicity, reliability, ease of use, hygiene, and robustness of the proposed designs are all advantageous.

### CROSS-REFERENCE TO RELATED APPLICATIONS

This application claims priority to U.S. Provisional Patent Application Ser. No. 62/124,662 filed Dec. 29, 2014 and titled SPILL RESISTING PET WATER VESSEL FOR USE IN MOTOR VEHICLES, the contents of which is incorporated herein in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

The field of this invention is liquid containing vessels, particularly liquid containing vessels for pets which resist spillage.

### BACKGROUND OF THE INVENTION

Ingestion of sufficient quantities of water is the single most important factor to sustain life for any living organism. As responsible pet owners it is vital that we provide our animals with an adequate supply of water at all times. Given that pets, particularly dogs, frequently ride in our motor vehicles with us, it is incumbent upon us to insure that drinking water is available to our pets while in our motor vehicles. This gives rise to a number of unique challenges as compared to providing water in a non-moving environment such as our home—where a conventional bowl may be relied upon to safely contain water without spilling.

There have been many attempts at a solution to the problem of carrying water in an open vessel which permits an animal to drink freely from it in a moving motor vehicle. The most rudimentary solution to the problem of carrying water in an open vessel which permits an animal to drink freely from it in a moving motor vehicle is the use of a conventional bowl, such as a water bowl as one might use in a stationary environment such as a home.

Another solution to the problem of carrying water in an open vessel which permits an animal to drink freely from it in a moving motor vehicle is the use of a drinking cup such as a plastic or paper cup.

Yet another solution to the problem of carrying water in an open vessel which permits an animal to drink freely from it in a moving motor vehicle is the use of a drinking glass.

Still another solution to the problem of carrying water in an open vessel which permits an animal to drink freely from it in a moving motor vehicle is the use of a closed water storage bottle with an integral drinking trough.

Previous spill resisting water vessels for pets have been disclosed. For example, U.S. Pat. No. 3,202,131, issued to W. Jones on Aug. 24, 1965, the contents of which are incorporated herein in its entirety, discloses a means of anchoring a pet water bowl for use in a motor vehicle to prevent movement.

U.S. Pat. No. 5,297,504, issued to Kenneth S. Carrico on Mar. 29, 1994, the contents of which are incorporated herein in its entirety, discloses a spill resisting pet water bowl for use in a motor vehicle which incorporates internal baffles and an annular rim.

U.S. Pat. No. 5,975,016, issued to Humphrey Erwin Wesenhagen on Nov. 2, 1999, the contents of which are incorporated herein in its entirety, illustrates a spill resisting pet feeding dish with an annular rim which blocks the ejection of food from the licking motion of the pet's tongue.

U.S. Pat. No. 6,032,824, issued to Mark E. Barrow on Mar. 7, 2000, the contents of which are incorporated herein in its entirety, discloses a spill-less wave bowl for pets for use in a motor vehicle with a downwardly facing annular rim.

U.S. Pat. No. 6,142,101, issued to Charles L. Pelsor. on Nov. 7, 200, the contents of which are incorporated herein in its entirety, discloses a spill-resisting water bowl for pets comprising internal partitions and multiple chambers.

U.S. Pat. No. 7,296,539, issued to Sandra Eloise Iljas on Nov. 20, 2007, the contents of which are incorporated herein in its entirety, discloses spill resisting food bowl for pets which may be mounted to a crate or vehicle.

U.S. Pat. No. 7,306,112, issued to Bradley K. Shepard on Dec. 11, 2007, the contents of which are incorporated herein in its entirety, discloses a spill resisting pet food and water bowl with an annular rim and a weighted bottom to resist tipping.

U.S. Pat. No. 7,600,486, issued to Natalie Ellis on Oct. 13, 2009, the contents of which are incorporated herein in its entirety, discloses a spill resisting pet water bowl for use in a motor vehicle with an inwardly turning annular rim and a floating baffle.

U.S. Pat. No. 8,146,534, issued to William L. Robertson on Apr. 3, 2012, the contents of which are incorporated herein in its entirety, discloses a gimbal mounted spill resisting pet water bowl for use in a motor vehicle.

U.S. Pat. App. No. 2006/0060149 filed by Richard Skowronski on Mar. 23, 2006 discloses a spill resisting pet water bowl for use in a motor vehicle with a plurality of inner chambers and baffles.

U.S. Pat. No. D704,383, issued to Anna M. Edlin on May 6, 2014, the contents of which are incorporated herein in its entirety, discloses an ornamental design for a spill resisting pet water bowl for use in a motor vehicle with an internal spiral and rim.

These prior attempts at a solution to the problem of a spill-resisting water vessel for pets in a motor vehicle fall into several categories, each with intrinsic disadvantages. Patents Jones U.S. Pat. No. 3,202,131, Iljas U.S. Pat. No. 7,296,539, Shepard U.S. Pat. No. 7,306,112, and Robertson U.S. Pat. No. 8,146,534 disclose mechanical mounting means including fasteners, ballast, and gimbals to prevent physical displacement or over-turning of the vessel. While this is a critical function, it does not solve the problem of the motion of the liquid inside the vessel resulting from vehicle motion or pet drinking motion which are the cause of liquid spilling out of the vessel.

Patents Carrico U.S. Pat. No. 5,297,504, Pelsor U.S. Pat. No. 6,142,101, Ellis U.S. Pat. No. 7,600,486, and Skowronski Patent App. No. 2006/0060149 describe the use of internal baffles or multiple chambers to mitigate the motion of liquid inside the vessel as a means of reducing the possibility of liquid spilling out of the vessel.

The third category of proposed solutions in the prior art is the use of an inward facing, downwardly pointing annular rim about the open periphery of the vessel to prevent liquids from exiting the vessel at this location due to vehicle dynamic or animal induced 100 forces. Patents Carrico U.S. Pat. No. 5,297,504, Wesenhagen U.S. Pat. No. 5,975,016, Barrow U.S. Pat. No. 6,032,824, Shepard U.S. Pat. No. 7,306,112, and Ellis U.S. Pat. No. 7,600,486 all disclose pet water vessels for use in a motor vehicle with downwardly pointing annular rims surrounding the open periphery of the vessel to prevent unintended egress, ejection or spillage of liquids contained therein as a result of vehicle dynamic forces or pet drinking forces.

While the present invention also discloses a downwardly pointing annular rims surrounding the open periphery of the vessel to prevent unintended egress, ejection or spillage of liquids contained therein as a result of vehicle dynamic forces or pet drinking forces, there are several critical distinctions and inventive steps distinguishing the present invention from all prior art.

The first distinction between the present invention and all prior art with downwardly pointing annular rims surrounding the open periphery of the vessel to prevent unintended egress, ejection or spillage of liquids contained therein as a result of vehicle dynamic forces or pet drinking forces is that the present invention is so configured, sized, and advantageously shaped to be placed in a typical cup holder such as may be found in the center console of a typical motor vehicle. This provides several advantages. First, rather than relying on ballast or frictional forces or mechanical attachment to prevent unwanted motion of the vessel, the placement of the vessel in the cup holder provides a robust, stable, secure means of preventing unwanted movement of the vessel due to vehicle dynamic forces or pet movements or drinking forces. Second, the location of the vehicle cup holder, generally between the front driver's seat and the front passenger seat is an ideal location to place the pet water vessel because it is proximal to the location of the pet if the pet is riding on the vehicle front passenger seat as is frequently the case, whether restrained by a harness or seat belt, in a car seat or carrier, or sitting on the seat. Similarly, if the pet is riding on a middle row or other seat, there are frequently cup holders proximal to these locations as well. Additionally, in the event that the vessel is placed in the cup holder located between the driver's seat and the front passenger seat it is ideally positioned to enable the driver to visually ascertain remaining water level and to safely and conveniently add additional water if required without the risk, discomfort and inconvenience of having to turn around or lean over as would be the case with a water vessel located on the floor of the vehicle.

The second distinction between the present invention and all prior art with inwardly facing, downwardly pointing annular rims surrounding the open periphery of the vessel to prevent unintended egress, ejection or spillage of liquids contained therein as a result of vehicle dynamic forces or pet drinking forces is that the vessel is advantageously constructed of a flexible material which provides two benefits. First, such materials permit the device to be molded as a single monolithic part including the molding of undercuts such as the undercuts required for an inwardly facing, downwardly pointing annular rim while still permitting the part to be removed from the mold rather than necessitating that the assembly be made of multiple parts without undercuts such as would be required if a rigid material is utilized. This one piece construction eliminates several disadvantages of a multi-piece assembly including higher cost, the possibility of losing or misplacing one or more of the components, the creation of interstitial spaces where dirt, germs, or bacteria can accumulate, the introduction of sharp edges which could possibly injure the pet or human if they make inadvertent contact with said edges, and the possibility of accidental separation of the parts, which would undermine the spill resisting functionality of the unit. Second, the flexible material is advantageously much safer for use in such a vessel than rigid materials. Given that the intended use is in a motor vehicle where sudden and unanticipated accelerations may occur without warning and where such unintended accelerations may cause the vehicle occupants to move suddenly relative to the interior of the vehicle with significant energy, there is a significant possibility that the pet may be subjected to such forces while drinking from the water vessel, thereby causing the pet's muzzle, lips, tongue, face or other body parts to impact the water vessel with significant force. If the water vessel is a rigid material such as rigid plastic or metal, such impact could cause serious injury. Advantageously the present invention is made of a soft, flexible material which will harmlessly deflect in the event of such an impact rather than injuring the pet.

One area of deficiency generally present in all of the proposed solutions to the problem of carrying water in an open vessel which permits an animal to drink freely from it in a moving motor vehicle is the tendency for water to slosh out of the vessel as a result both of vehicle motion and the tongue dipping which characterizes dog drinking mechanics.

Another area of deficiency generally present in all of the proposed solutions to the problem of carrying water in an open vessel which permits an animal to drink freely from it in a moving motor vehicle is the potential for injury to the animal as a result of impact with the hard and or rigid materials from which the vessels are constructed in the event that vehicle motion causes a sudden or high speed relative motion between the animals mouth or snout and the vessel.

Yet another area of deficiency generally present in some of the proposed solutions to the problem of carrying water in an open vessel which permits an animal to drink freely from it in a moving motor vehicle is the necessity of holding or stabilizing the vessel to prevent spilling and/or enable drinking which is a distraction to the driver of the vehicle.

Yet another area of deficiency generally present in some of the proposed solutions to the problem of carrying water in an open vessel which permits an animal to drink freely from it in a moving motor vehicle is the necessity of placing the vessel on the floor or seat of the vehicle as opposed to in a cup holder which provides mechanical stability, resistance to movement from dynamic forces related to vehicle motion or contact with the dogs tongue, muzzle or other body parts, and also optimally locates the vessel for convenience and human supervision for dogs which are riding in the passenger seat of a vehicle.

Still another area of area of deficiency generally present in all of the proposed solutions to the problem of carrying water in an open vessel which permits an animal to drink freely from it in a moving motor vehicle is the incompatibility of the vessel with the existing cup holders in the vehicle.

A further deficiency generally present in some of the proposed solutions to the problem of carrying water in an open vessel which permits an animal to drink freely from it in a moving motor vehicle is the high cost of purchase of the vessel.

Yet another deficiency generally present in some of the proposed solutions to the problem of carrying water in an open vessel which permits an animal to drink freely from it in a moving motor vehicle is the relative flimsiness of the construction of the vessel and the need to frequently replace it, and the cost and environmental impact of disposal.

While there are presently a number of proposed solutions to the problem of carrying water in an open vessel which permits an animal to drink freely from it in a moving motor vehicle, none have been conceived or implemented to permit an easy to use, robust, spill resisting due to vehicle motion or pet drinking mechanics, long lasting and cost effective solution which fits in a vehicle cup holder and would be optimal for the application.

### SUMMARY

Spill resisting water vessels for pets for use in a motor vehicle embodying the principles of this invention solve the problems of an easy to use, robust, spill resisting due to vehicle motion or pet drinking mechanics, long lasting and cost effective solution which fits in a vehicle cup holder.

The several embodiments of the invention employ designs, materials, and manufacturing methods which are inexpensive and consistent with current manufacturing practices. The functionality, size, cost, simplicity, reliability and robustness of the proposed designs are all advantageous.

Implementations following the principles of this invention allow the advantageous modality of hygienic, easy to use, cost-effective, robust pet drinking water carrying means which fit in a vehicle cup holder and which would be optimal for the application.

This summary is intended to introduce the inventive concepts, principles and embodiments, not to define them

### DESCRIPTION OF DRAWINGS

FIG. 1 shows a perspective view of a spill resisting water vessel embodying teachings of the present disclosure;

FIG. 2 shows a top plan view of a spill resisting water vessel embodying teachings of the present disclosure;

FIG. 3 shows a cross section side view of a spill resisting water vessel embodying teachings of the present disclosure;

FIG. 4A shows a cross section side view of a spill resisting water vessel embodying teachings of the present disclosure with liquid contents being accelerated laterally;

FIG. 4B shows a cross section side view of a spill resisting water vessel embodying teachings of the present disclosure with liquid contents being accelerated laterally and following the contours of the return lip to be redirected into the vessel.

### DETAILED DESCRIPTION

In conjunction with the included drawings, this detailed description is intended to impart an understanding of the teachings herein and not to define their metes and bounds. Several particular implementations, illustrating aspects of the present teaching, are presented in detail below. Some of the many possible variations and versions are also described.

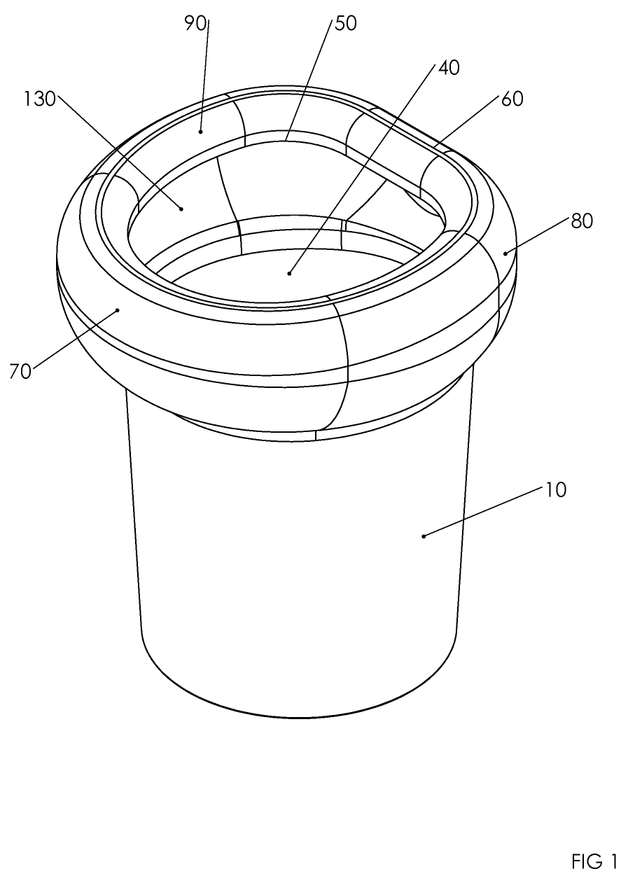

FIG. 1 shows a perspective view of a spill resisting water vessel 10 embodying teachings of the present disclosure wherein the distinctive shape of the vessel may be plainly seen, particularly the flared rim 80, the projecting rim 70 at the front of the rim 70 and the flattened rim 60 at the rear of the rim 70. Also visible in this view is the deceleration ramp 130.

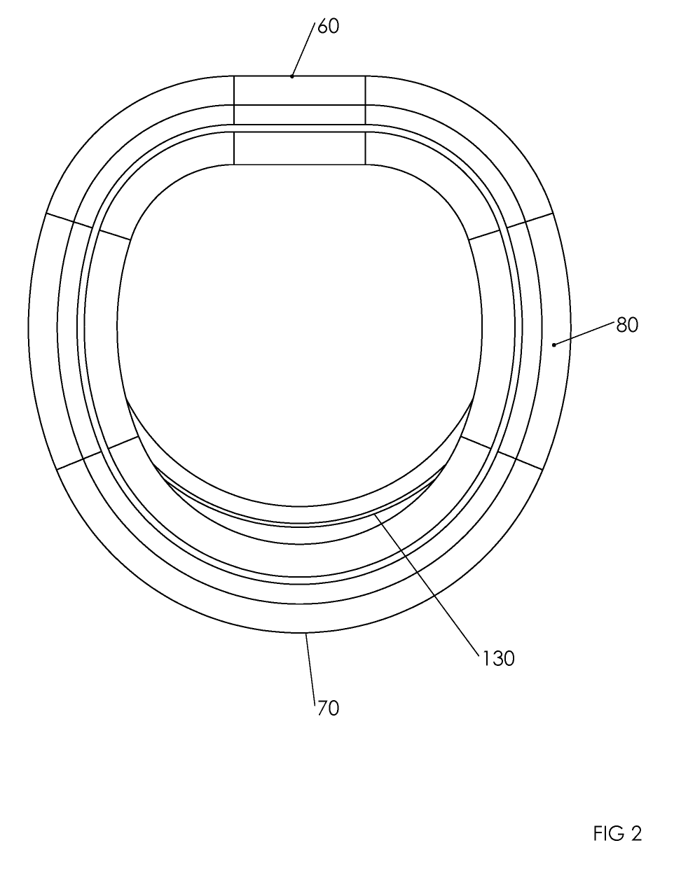

FIG. 2 shows a top plan view of a spill resisting water vessel 10 embodying teachings of the present disclosure wherein the asymmetrical form of flared rim 80 is clearly displayed including flattened rim 60 at the rear of rim 80, seen in this figure at the 12 o'clock position, and projecting rim 70, sin in this figure at the 6 o'clock position.

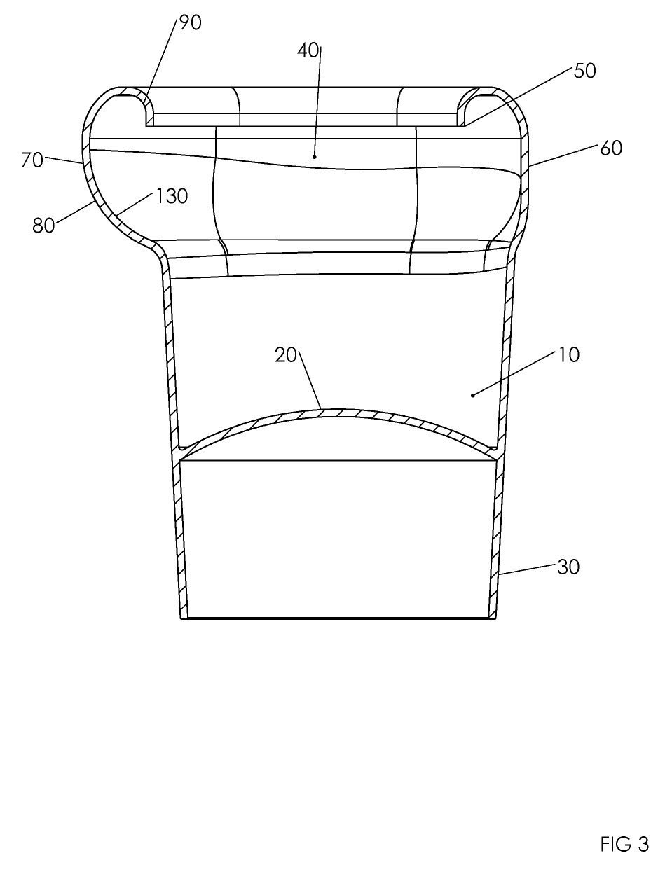

FIG. 3 shows a cross section side view of a spill resisting water vessel 10 embodying teachings of the present disclosure wherein the distinctive cross sectional shape of the vessel 10 may be plainly seen including the raised bottom 20, asymmetrical rim 80 including projecting rim 70 and flattened rim 60, and the deceleration ramp 130 and return lip 90 leading to lip 50.

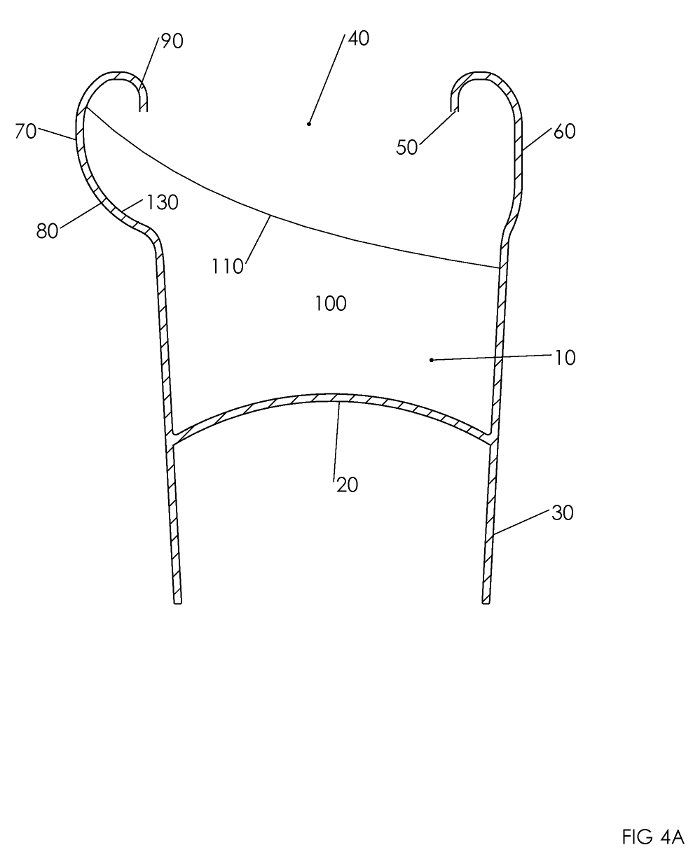

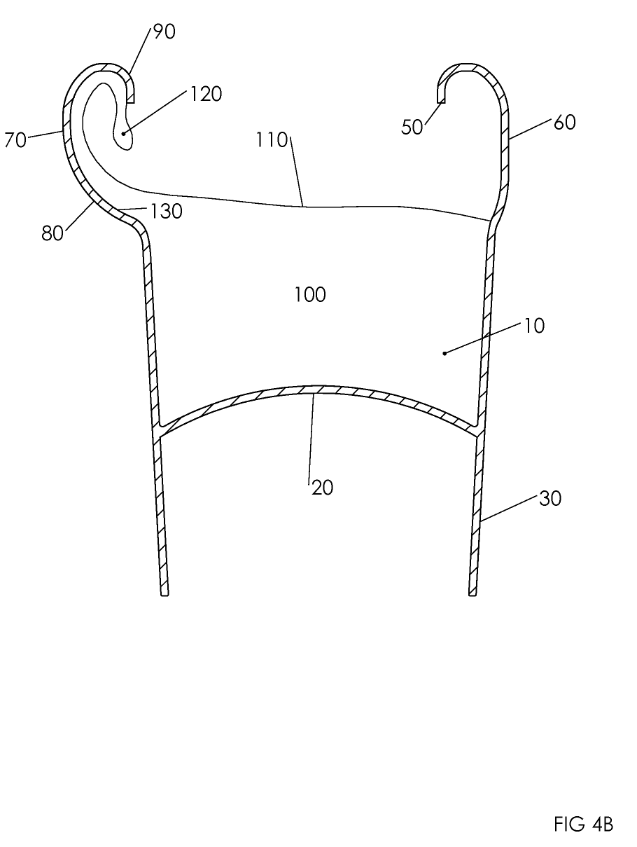

FIG. 4A shows a cross section side view of a spill resisting water vessel 10 embodying teachings of the present disclosure with liquid contents 100 being accelerated laterally which causes the liquid surface 110 to tilt at an angle relative to the horizontal, causing the forward edge, or edge pointing in the direction of the acceleration vector to climb vertically up projecting rim 70.

FIG. 4B shows a cross section side view of a spill resisting water vessel 10 embodying teachings of the present disclosure with liquid contents 100 being accelerated laterally which causes the liquid surface 110 to tilt at an angle relative to the horizontal, causing the forward edge, or edge pointing in the direction of the acceleration vector to climb vertically up projecting rim 70 and, upon continued climbing, to curve around return rim 90 until water drop 120 passes rim 50 and is redirected back into the interior of vessel 10.

Operation

The operation of the preferred embodiment of the invention is as follows:

FIG. 1 illustrates the preferred embodiment of the present invention which is so sized and shaped as to fit into a standard cup holder or drink holder as found in a typical motor vehicle. This provides a stable location to place the vessel where it is unlikely to tip or fall due to vehicle motion and where it is also within convenient reach of the vehicle driver and passengers and within reach of a pet to enable them to drink from.

The preferred embodiment of the present invention is manufactured out of food grade silicone to create a soft, flexible form which retains its shape, is hygienic, is dishwasher safe, and has no hard surfaces or edges which might possibly injure an animal if they were subjected to a sudden acceleration which causes them to collide with the vessel while drinking from or in close proximity to the vessel 10.

Additionally, spill resistant vessel 10 has been so designed as to incorporate asymmetrical features which both optimize spill resisting functionality and allow it to fit into the potentially restrictive space surrounding the cup holder or drink holder in some motor vehicles. For example, many cup holders or drink holders are located proximal to or integral with a center console or arm rest which has a vertical space immediately behind the cup holder or drink holder receptacle, thereby restricting the amount of space behind the receptacle. For this reason, flared rim 80 has been flattened in the vicinity of flattened rim 60 at the rear of the vessel 10 to allow it to fit in the space typically allotted to a cup holder or drink holder in a motor vehicle. Conversely, most motor vehicles have ample space forward of the cup holder or drink holder receptacle, so flared rim 80 has been extended on the front of vessel 10 to create projecting rim 70. These asymmetrical features also correspond to the inertial properties most likely to be experienced in the respective areas. For example, it is far more likely that a large, unanticipated deceleration will be experienced at the front of the vessel 10 as the result of emergency braking, than at the rear of the cup as a result of a rapid acceleration or ‘jack rabbit’ start.

Referring now to FIG. 4A which shows a cross section side view of a spill resisting water vessel 10 embodying teachings of the present disclosure with liquid contents 100 being accelerated laterally which causes the liquid surface 110 to tilt at an angle relative to the horizontal, causing the forward edge, or edge pointing in the direction of the acceleration vector to climb vertically up projecting rim 70 it may be plainly seen how flared rim 80 advantageously accommodates the increased volume of water in the elevated area of the rim due to such acceleration events.

Still referring to FIG. 4A it may be seen how deceleration ramp 130 serves to decelerate or slow down the advancing front of liquid 100 as it is accelerated towards projecting rim 70 by presenting both a decreased slope angle as well as an increased cross sectional volume to the advancing volume of liquid.

Referring now to FIG. 4B it may be further seen how upon the continued acceleration driven forward and upward advance of liquid 100, the leading edge of liquid 100 continues to climb vertically up flared rim 80 until eventually it contacts return rim 90 which caused liquid 100 to roll back over on itself, effectively redirecting the acceleration induced energy of the advancing liquid back in the downward direction, thereby redirecting liquid 100 back into vessel 10 rather than continuing its advance outward and upward and eventually over the rim 50 of vessel 10, thereby causing a spill.

Similarly, still referring to FIG. 4B, when an animal, particularly a dog, drinks from vessel 10, the mechanics of drinking involve a dipping and retraction of the tongue which pulls water into the animal's mouth, but there is a fair amount of peripheral splashing and water displacement which also occurs. The proprietary geometry of the spill resisting vessel 10 including the flared rim 80, the deceleration ramp 130 and the return rim 90 advantageously reduce spillage due to splashing and sloshing which result from the mechanics of animal drinking. This is a further benefit of this design.

Variations

There are many possible variations of the implementations described above consistent with the teaching of the present disclosure. Variations include different sizes, shapes, colors, textures, and materials.

In the preferred embodiment, the vessel is made of food grade silicone, but could be made of other materials including rubber, plastic, metal, paper, cardboard or other materials. The vessel could be made to be disposable. The vessel could be configured to be placed somewhere other than a cup holder or drink holder, for example to sit on the floor or seat of a motor vehicle, or to be hung from any protruding object in a motor vehicle including an armrest, door handle, head rest, or other suitable structure. The vessel could also be designed to rest within a pet car seat or pet enclosure, or to be integrally formed with a pet car seat, or pet enclosure.

The vessel could include baffles or other flow disruption devices to aid in the deceleration and redirection of the liquid in an effort to reduced sloshing and spills.

The shape, profile, depth, and height of the flared rim could be varied or altered to further aid in the reduction of sloshing and splashing and the retention of liquid contents within the vessel.

The top rim of the vessel could be made to be raised higher in the front and/or sides in an effort to more effectively combat the greater acceleration forces of the liquid likely to be encountered in these areas.

Absorbent materials could be attached to or incorporated into or placed adjacent to the vessel in order to absorb any liquid which does find its way out of the cup.

In another embodiment, means could be incorporated into the vessel for heating or cooling the liquid contents, including a compartment within the hollow base which receives or contains an freezable element or ice, which would permit the user to place the empty vessel in the freezer for a period of time, then place it in a motor vehicle, including a motor vehicle with an elevated interior temperature and the thermal mass of the ice or ice pack or freezable element would cool and maintain the reduced temperature of the liquid contents for a period of time.

In yet another embodiment it would be possible to attach or incorporate a gas tight lid or sealing element to the vessel to make it spill proof for transportation or stowage.

In broad embodiment, the present invention is a spill resisting water vessel for pets for use in a motor which solves the problems of water sloshing and spilling due to both vehicle motion and pet drinking mechanics, which fits in a vehicle cup holder.

The several embodiments of the invention employ designs, materials, and manufacturing methods which are inexpensive and consistent with current manufacturing practices. The functionality, size, cost, simplicity, reliability, ease of use, hygiene, and robustness of the proposed designs are all advantageous

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A spill resisting water vessel for pets for use in motor vehicles with an inward facing, downwardly pointing annular rim surrounding the open periphery of the vessel to prevent unintended egress, ejection or spillage of liquids contained therein as a result of vehicle dynamic forces or pet drinking forces which is made of soft flexible material such as food grade silicone which will not injure a pet in the event of a collision between the pet and the water vessel and which advantageously permits the undercut annular rim of the vessel to be molded integrally with the vessel and the entire component removed from the mold without damage.

2. The spill resisting water vessel for pets of claim 1 which fits into a vehicle cup holder.

3. The spill resisting water vessel for pets of claim 1 which has a base portion of such a diameter as to fit within a typical vehicle cup holder with a transitioning deceleration shoulder which leads to a larger diameter upper portion which includes an inward facing, downwardly pointing annular rim surrounding the open periphery.

4. The spill resisting water vessel for pets of claim 1 which has a raised bottom portion of substantially convex profile which serves both as a settling dome to permit debris and detritus to fall to and collect in the circumferential low point created where the convex bottom meets the side walls of the vessel after the fashion of the similarly shaped bottom frequently found in wine bottles for the same purpose; and also as a false bottom which eliminates the necessity for the pet to insert their muzzle deeply into the vessel to drink.
